(19) United States
(12) Patent Application Publication
(10) Pub. No.: US 2022/0274250 A1
(43) Pub. Date: Sep. 1, 2022

(54) ROBOT DEVICE AND LIQUID SUPPLY DEVICE

(71) Applicant: AISIN CORPORATION, Aichi (JP)

(72) Inventors: Shinya ICHIKAWA, Kariya-shi, Aichi-ken (JP); Tomonari OKAMOTO, Kariya-shi, Aichi-ken (JP); Tomomi ISHIKAWA, Kariya-shi, Aichi-ken (JP); Masahiro ASAI, Kariya-shi, Aichi-ken (JP); Reishi KOROGI, Kariya-shi, Aichi-ken (JP); Masayuki FUJIRAI, Kariya-shi, Aichi-ken (JP); Noriomi FUJII, Kariya-shi, Aichi-ken (JP)

(73) Assignee: AISIN CORPORATION, Aichi (JP)

(21) Appl. No.: 17/629,862

(22) PCT Filed: Sep. 14, 2020
(86) PCT No.: PCT/JP2020/034783

§ 371 Date: Jan. 25, 2022

(30) Foreign Application Priority Data
Sep. 30, 2019 (JP) 2019-179915
Mar. 18, 2020 (JP) 2020-047855

(51) Int. Cl. B25J 9/10; B25J 9/16; B25J 13/08

(52) U.S. Cl. CPC B25J 9/1075; B25J 9/1674; B25J 13/088

(57) ABSTRACT

A robot device of the present disclosure includes at least one artificial muscle that operates by being supplied with liquid; and a liquid supply device that supplies and discharges the liquid to/from the artificial muscle, and the liquid supply device includes: a liquid storage part that stores the liquid; a pressure regulating valve that regulates pressure of the liquid from the liquid storage part and supplies the liquid to the artificial muscle; and a liquid keeping part that allows the artificial muscle to keep the liquid supplied to the artificial muscle, according to occurrence of an abnormality, and the liquid supply device can allow the artificial muscle that operates by being supplied with liquid to operate properly.

### CROSS REFERENCE TO RELATED APPLICATIONS

This application is a National Stage of International Application No. PCT/JP2020/034783 filed Sep. 14, 2020, which designates the United States, incorporated herein by reference, and which claims the benefit of priority from Japanese Patent Application No. 2019-179915 filed Sep. 30, 2019 and Japanese Patent Application No. 2020-047855 filed Mar. 18, 2020, the entire contents of which are incorporated herein by reference.

### TECHNICAL FIELD

The present disclosure relates to a robot device including at least one artificial muscle that operates by being supplied with liquid, and to a liquid supply device that supplies and discharges liquid to/from the artificial muscle.

### BACKGROUND ART

Conventionally, for a fluid pressure actuator that forms a McKibben artificial muscle, there is known a fluid pressure actuator including: an actuator main body part including a cylindrical tube that expands and contracts by fluid pressure, and a sleeve which is a structure obtained by braiding cords oriented in a predetermined direction and which covers an outer circumferential surface of the tube; and a sealing mechanism that seals an end part of the actuator main body part in an axial direction of the actuator main body part (see, for example, Patent Literature 1). The fluid pressure actuator can obtain a tensile force by supplying fluid into the tube to allow the tube to radially expand and axially contract.

### CITATIONS LIST

### Patent Literature

Patent Literature 1: JP 2018-35930 A

### SUMMARY OF THE DISCLOSURE

### Technical Problems

A fluid pressure actuator such as that described above can easily achieve weight reduction, and can further increase a force-to-self-weight ratio compared to a motor and a hydraulic cylinder, by using liquid such as hydraulic oil as working fluid. Note, however, that for a liquid supply device that supplies and discharges liquid to/from a fluid pressure actuator which is used as an artificial muscle, there has not been proposed any liquid supply device having sufficient practicality, and there is a demand for a liquid supply device that can allow a fluid pressure actuator to operate properly.

Therefore, the present disclosure allows an artificial muscle that operates by being supplied with liquid to operate properly.

### Solutions to Problems

A robot device of the present disclosure is a robot device including: at least one artificial muscle that operates by being supplied with liquid; and a liquid supply device that supplies and discharges the liquid to/from the artificial muscle, and the liquid supply device includes: a liquid storage part that stores the liquid; a pressure regulating valve that regulates pressure of the liquid from the liquid storage part and supplies the liquid to the artificial muscle; and a liquid keeping part that allows the artificial muscle to keep the liquid supplied to the artificial muscle, according to occurrence of an abnormality.

In the robot device of the present disclosure, pressure of liquid from a liquid storage part side is regulated by the pressure regulating valve, and the liquid is supplied to the artificial muscle. By this, pressure of liquid from the liquid storage part side is promptly regulated according to a requirement, enabling the artificial muscle to operate with excellent responsiveness and high accuracy. Furthermore, when some kind of abnormality has occurred, the liquid keeping part of the liquid supply device allows the artificial muscle to keep liquid supplied to the artificial muscle. By this, even if some kind of abnormality has occurred, a sudden change in the state of the artificial muscle is inhibited, by which occurrence of unintended operation of a drive target which is driven by the artificial muscle can be excellently suppressed. As a result, the robot device of the present disclosure can allow the artificial muscle to operate properly.

### BRIEF DESCRIPTION OF DRAWINGS

FIG. 1 is a schematic configuration diagram showing a liquid supply device of the present disclosure.

FIG. 2 is a block diagram showing a control device in the liquid supply device of the present disclosure.

FIG. 3 is a schematic configuration diagram showing another liquid supply device of the present disclosure.

FIG. 4 is a schematic configuration diagram showing still another liquid supply device of the present disclosure.

FIG. 5 is a schematic configuration diagram showing another linear solenoid valve that can be applied to the liquid supply device of the present disclosure.

FIG. 6 is a schematic configuration diagram for describing operation of the linear solenoid valve shown in FIG. 5.

FIG. 7 is a schematic configuration diagram for describing operation of the linear solenoid valve shown in FIG. 5.

FIG. 8 is a schematic configuration diagram showing still another linear solenoid valve that can be applied to the liquid supply device of the present disclosure.

FIG. 9 is a schematic configuration diagram for describing operation of the linear solenoid valve shown in FIG. 8.

FIG. 10 is a schematic configuration diagram for describing operation of the linear solenoid valve shown in FIG. 8.

### DESCRIPTION OF EMBODIMENTS

Next, an embodiment for carrying out various aspects of the present disclosure will be described with reference to the drawings.

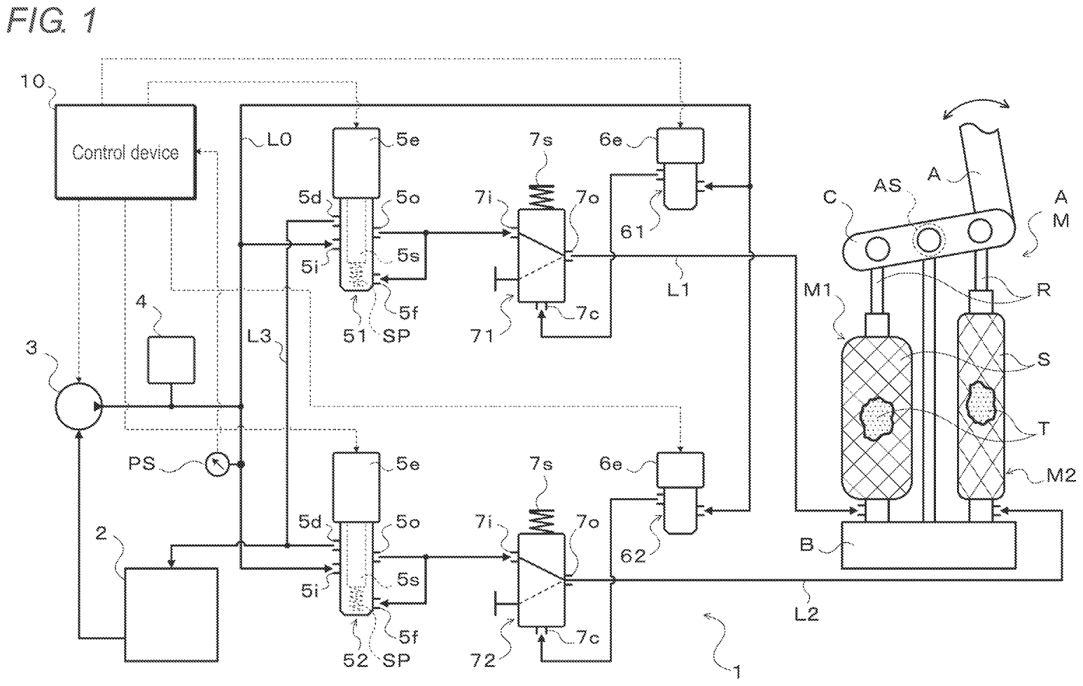

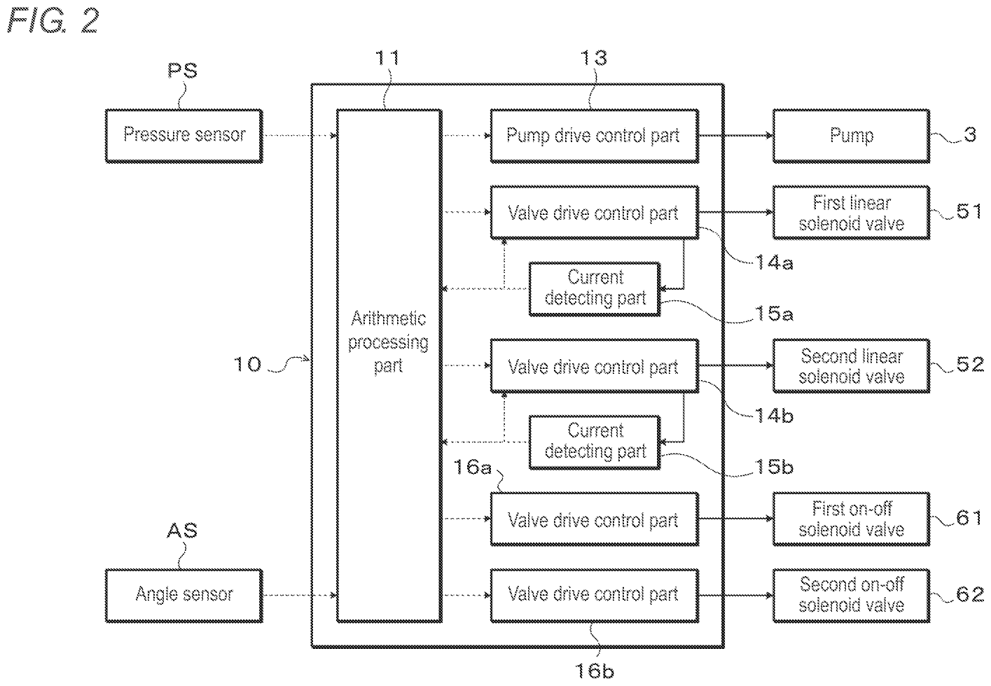

FIG. 1 is a schematic configuration diagram showing a liquid supply device 1 of the present disclosure. The liquid supply device 1 shown in the drawing is a drive device that drives an artificial muscle unit AM using oil pressure by supplying and discharging hydraulic oil (liquid) to/from two hydraulic actuators M1 and M2 included in the artificial muscle unit AM. The artificial muscle unit AM includes, as shown in the drawing, a base member B, a link C supported by the base member B, and a moving arm A fixed to or integrated with the link C, in addition to the two hydraulic actuators M1 and M2. The artificial muscle unit AM forms, together with the liquid supply device 1, a robot device of the present disclosure that includes, for example, a hand part and a robot arm. Note, however, that the artificial muscle unit AM may form a robot device including a robot arm having attached to its end an element other than the hand part, such as a tool, e.g., a drill bit, or a pressing member that presses, for example, a switch, a walking robot, a wearable robot, etc. The hydraulic actuators M1 and M2 of the artificial muscle unit AM both form McKibben artificial muscles, and in the present embodiment, the hydraulic actuators M1 and M2 have the same specifications. Each of the hydraulic actuators M1 and M2 includes a tube T that expands and contracts by pressure of hydraulic oil; and a braided sleeve S that covers the tube T.

The tube T of each of the hydraulic actuators M1 and M2 is formed in cylindrical shape and made of an elastic material having high oil resistance, e.g., a rubber material, and both end parts of the tube T are sealed by sealing members. An inlet and an outlet for hydraulic oil are formed in the sealing member on one end side (lower end side in the drawing) of the tube T, and a connecting rod R is fixed to the sealing member on the other end side (upper end side in the drawing) of the tube T. The braided sleeve S is formed in cylindrical shape by braiding a plurality of cords oriented in a predetermined direction such that the cords cross each other, and can contract axially and radially. For the cords that form the braided sleeve S, fiber cords, high-strength fibers, metal cords made of fine filaments, etc., can be adopted. By supplying hydraulic oil into the tube T of each of the hydraulic actuators M1 and M2 through the inlet and outlet to increase pressure of hydraulic oil in the tube T, the tube T radially expands and axially contracts by action of the braided sleeve S.

In the artificial muscle unit AM, the sealing member on the one end side (hydraulic oil inlet and outlet side) of each of the hydraulic actuators M1 and M2 is connected to the base member B via, for example, a joint such as a universal joint, or is fixed to the base member B. In addition, an end part of the connecting rod R of each of the hydraulic actuators M1 and M2 is pivotably connected to a corresponding end part of the link C. Furthermore, a central part in a longitudinal direction of the link C is pivotably supported by the base member B. By this, oil pressure in the tube T of the hydraulic actuator M1 differs from oil pressure in the tube T of the hydraulic actuator M2, by which the link C and the moving arm A which are drive targets pivot (move) with respect to the base member B to change the pivot angles of the link C and the moving arm A with respect to the base member B, and forces can be transmitted to the moving arm A from the hydraulic actuators M1 and M2. In the present embodiment, a pair of the hydraulic actuators M1 and M2 is antagonistically driven by oil pressure from the liquid supply device 1, with a state of the tubes T axially contracting by a predetermined amount (e.g., on the order of 10% of equilibrium length) being an initial state. In addition, as shown in FIG. 1, the artificial muscle unit AM includes an angle sensor AS that detects pivot angles which are the amounts of movement of the link C and the moving arm A with respect to the base member B.

As shown in FIG. 1, the liquid supply device 1 includes a tank 2 serving as a liquid storage part that stores hydraulic oil; a pump 3; an accumulator 4 that accumulates oil pressure generated by the pump 3; first and second linear solenoid valves 51 and 52 serving as pressure regulating valves; first and second on-off solenoid valves 61 and 62; first and second on-off valves 71 and 72; and a control device 10 that controls the pump 3, the first and second linear solenoid valves 51 and 52, and the first and second on-off solenoid valves 61 and 62. The pump 3 is, for example, a motor-driven pump, and sucks hydraulic oil from the tank 2 and discharges the hydraulic oil to an oil passage (liquid passage) L0 formed in a valve body which is not shown. In addition, the accumulator 4 is connected to the oil passage (liquid passage) L0 near a discharge port of the pump 3.

The first and second linear solenoid valves 51 and 52 each include an electromagnetic part 5e whose current passage is controlled by the control device 10, a spool 5s, a spring SP that biases the spool 5s toward an electromagnetic part 5e side (from an output port 5o side to an input port 5i side, an upper side in FIG. 1), etc., and are disposed in the valve body. In addition, the first and second linear solenoid valves 51 and 52 each include the input port 5i that communicates with the oil passage L0 of the valve body; the output port 5o that can communicate with the input port 5i; a feedback port 5f that communicates with the output port 5o; and a drain port 5d that can communicate with the input port 5i and the output port 5o. In the present embodiment, the first and second linear solenoid valves 51 and 52 each are a normally closed valve that opens when a current is supplied to the electromagnetic part 5e, and each electromagnetic part 5e allows a corresponding spool 5s to axially move according to a current applied thereto. By this, thrust given to the spool 5s from the electromagnetic part 5e (coil) by feeding the electromagnetic part 5e, a biasing force of the spring SP, and thrust toward the electromagnetic part 5e side that is given to the spool 5s by action of oil pressure supplied to the feedback port 5f from the output port 5o are balanced, by which hydraulic oil from the pump 3 side that is supplied to the input port 5i can flow out from the output port 5o such that the hydraulic oil flowing out from the output port 5o has desired pressure. In addition, as shown in FIG. 1, the drain ports 5d of the first and second linear solenoid valves 51 and 52 each communicate with the inside of the tank 2 (liquid storage part) through an oil passage L3 formed in the valve body.

The first and second on-off solenoid valves 61 and 62 each include an electromagnetic part 6e whose current passage is controlled by the control device 10; an input port that communicates with the oil passage L0; and an output port. The first and second on-off solenoid valves 61 and 62 each output signal pressure by allowing hydraulic oil from the pump 3 side that is supplied to the input port to flow out from the output port according to passage of a current through the electromagnetic part 6e.

The first and second on-off valves 71 and 72 each are a normally closed spool valve including a spool which is not shown and a spring 7s, and are disposed in the valve body. The first on-off valve 71 includes an input port 7i that communicates with the output port 5o of the first linear solenoid valve 51 through an oil passage formed in the valve body; an output port 7o that communicates with the inlet and outlet for hydraulic oil of the hydraulic actuator M1 (tube T) through an oil passage L1 formed in the valve body; and a signal pressure input port 7c that communicates with the output port of the first on-off solenoid valve 61 through an oil passage formed in the valve body. In addition, the second on-off valve 72 includes an input port 7i that communicates with the output port 5o of the second linear solenoid valve 52 through an oil passage formed in the valve body; an output port 7o that communicates with the inlet and outlet for hydraulic oil of the hydraulic actuator M2 (tube T) through an oil passage L2 formed in the valve body; and a signal pressure input port 7c that communicates with the output port of the second on-off solenoid valve 62 through an oil passage formed in the valve body.

When signal pressure is not supplied to the signal pressure input port 7c from the first or second on-off solenoid valve 61 or 62, the spool of a corresponding one of the first and second on-off valves 71 and 72 shuts down communication between the input port 7i and the output port 7o by a biasing force of the spring 7s, and closes the output port 7o, i.e., the oil passage L1 or L2 (see a dashed line in the drawing). In addition, when signal pressure is supplied to the signal pressure input port 7c from the first or second on-off solenoid valve 61 or 62 according to passage of a current through the electromagnetic part 6e, the spool of a corresponding one of the first and second on-off valves 71 and 72 allows the input port 7i and the output port 7o to communicate with each other against a biasing force of the spring 7s (see a solid line in the drawing).

The control device 10 in the liquid supply device 1 includes a microcomputer including a CPU, a ROM, a RAM, an input-output interface, etc., various types of logic ICs, etc. (none of them are shown). The control device 10 accepts, as input, detection values of a pressure sensor PS that detects pressure of hydraulic oil in the oil passage L0 on a downstream side of the accumulator 4, the angle sensor AS of the artificial muscle unit AM, voltage sensors (not shown) that detect voltages at power supplies for the first and second linear solenoid valves 51 and 52 and the first and second on-off solenoid valves 61 and 62, various types of sensors provided in the artificial muscle unit AM, etc.

In addition, in the control device 10, by at least either one of hardware such as the CPU, the ROM, the RAM, and the logic ICs and software such as various types of programs installed in the ROM, there are constructed, as functional blocks (modules), an arithmetic processing part 11, a pump drive control part 13 connected to the pump 3, a valve drive control part 14a connected to the first linear solenoid valve 51, a valve drive control part 14b connected to the second linear solenoid valve 52, a current detecting part 15a that detects a current flowing through the electromagnetic part 5e of the first linear solenoid valve 51, a current detecting part 15b that detects a current flowing through the electromagnetic part 5e of the second linear solenoid valve 52, a valve drive control part 16a connected to the first on-off solenoid valve 61, and a valve drive control part 16b connected to the second on-off solenoid valve 62.

When oil pressure in the oil passage L0 detected by the pressure sensor PS is less than or equal to a predetermined pump drive threshold value, the arithmetic processing part 11 in the control device 10 transmits a pump drive instruction to the pump drive control part 13 until the oil pressure in the oil passage L0 reaches a predetermined pump stop threshold value. In addition, the arithmetic processing part 11 calculates oil pressure instruction values indicating oil pressure to be outputted from the first and second linear solenoid valves 51 and 52, and calculates target currents which are target values of currents supplied to the electromagnetic parts 5e of the first and second linear solenoid valves 51 and 52 and which correspond to the oil pressure instruction values. Furthermore, the arithmetic processing part 11 transmits an on instruction for opening the first and second on-off valves 71 and 72 to the valve drive control parts 16a and 16b while the artificial muscle unit AM operates.

In addition, the arithmetic processing part 11 monitors currents detected by the current detecting parts 15a and 15b, and for example, when a value obtained by subtracting a current detected by the current detecting part 15a and/or 15b from a target current is greater than or equal to a predetermined threshold value, the arithmetic processing part 11 considers that an abnormality has occurred in supply of hydraulic oil from at least either one of the first and second linear solenoid valves 51 and 52 to a corresponding one of the hydraulic actuators M1 and M2, and thus transmits an off instruction for closing a corresponding one of the first and second on-off valves 71 and 72 to a corresponding one of the valve drive control parts 16a and 16b. Furthermore, when a failure is detected in at least any one of the pump 3, the first and second linear solenoid valves 51 and 52, and the first and second on-off solenoid valves 61 and 62, i.e., the liquid supply device 1, the arithmetic processing part 11 considers that an abnormality has occurred in supply of hydraulic oil from at least either one of the first and second linear solenoid valves 51 and 52 to a corresponding one of the hydraulic actuators M1 and M2, and thus transmits an off instruction for closing a corresponding one of the first and second on-off valves 71 and 72 to a corresponding one of the valve drive control parts 16a and 16b. In addition, when a failure (abnormality) is detected in the control device 10 (other than the arithmetic processing part 11), the arithmetic processing part 11 considers that an abnormality has occurred in supply of hydraulic oil from at least either one of the first and second linear solenoid valves 51 and 52 to a corresponding one of the hydraulic actuators M1 and M2, and thus transmits an off instruction for closing a corresponding one of the first and second on-off valves 71 and 72 to a corresponding one of the valve drive control parts 16a and 16b.

Furthermore, when a failure (abnormality) is detected in at least either one of the pressure sensor PS and the angle sensor AS, the arithmetic processing part 11 considers that an abnormality has occurred in supply of hydraulic oil from at least either one of the first and second linear solenoid valves 51 and 52 to a corresponding one of the hydraulic actuators M1 and M2, and thus transmits an off instruction for closing a corresponding one of the first and second on-off valves 71 and 72 to a corresponding one of the valve drive control parts 16a and 16b. In addition, when a difference between a pivot angle (amount of movement) detected by the angle sensor AS and a target pivot angle (target amount of movement) of the link C and the moving arm A with respect to the base member B continuously reaches a predetermined threshold value or higher a predetermined number of times (including once), the arithmetic processing part 11 considers that an abnormality has occurred in supply of hydraulic oil from at least either one of the first and second linear solenoid valves 51 and 52 to a corresponding one of the hydraulic actuators M1 and M2, and thus transmits an off instruction for closing a corresponding one of the first and second on-off valves 71 and 72 to a corresponding one of the valve drive control parts 16a and 16b. Note that the target pivot angle of the link C and the moving arm A with respect to the base member B is determined from, for example, structures (specifications) of a connecting part (articulation) between the base member B and the link C and connecting parts between the link C and the hydraulic actuators M1 and M2, etc., and a target position of the moving arm A.

The pump drive control part 13 in the control device 10 controls (duty control) the pump 3 to suck hydraulic oil from the tank 2 and discharge the hydraulic oil, while receiving a pump drive instruction from the arithmetic processing part 11. Namely, the pump 3 is intermittently driven so that oil pressure in the oil passage L0 detected by the pressure sensor PS is maintained at predetermined target pressure, and while the pump 3 is stopped, hydraulic oil accumulated in the accumulator 4 flows into the oil passage L0, by which oil pressure in the oil passage L0 is maintained at the target pressure. By this, it becomes possible to reduce power consumption of the pump 3.

The valve drive control parts 14a and 14b in the control device 10 each include a target voltage setting part that sets a target voltage by feedforward control and feedback control so that a current detected by a corresponding current detecting part 15a or 15b matches a target current set by the arithmetic processing part 11; a PWM signal generating part that converts the target voltage into a PWM signal; and a drive circuit that includes, for example, two switching elements (transistors) and applies a current to the electromagnetic part 5e of a corresponding one of the first and second linear solenoid valves 51 and 52 according to the PWM signal from the PWM signal generating part. By this, the first and second linear solenoid valves 51 and 52 are controlled to generate oil pressure determined based on oil pressure instruction values (target currents). Note, however, that the target voltage setting part may set a target voltage only by feedforward control.

The valve drive control parts 16a and 16b in the control device 10 each supply a current to the electromagnetic part 6e of a corresponding one of the first and second on-off solenoid valves 61 and 62 so as to output signal pressure to a corresponding one of the first and second on-off valves 71 and 72, while receiving an on instruction from the arithmetic processing part 11. In addition, when the valve drive control part 16a or 16b receives an off instruction from the arithmetic processing part 11, the valve drive control part 16a or 16b stops the supply of a current to the electromagnetic part 6e of a corresponding one of the first and second on-off solenoid valves 61 and 62 so as to stop the output of signal pressure to a corresponding one of the first and second on-off valves 71 and 72.

When the artificial muscle unit AM operates by supplying hydraulic oil to each of the hydraulic actuators M1 and M2 serving as artificial muscles from the liquid supply device 1 configured in the above-described manner, the first and second on-off valves 71 and 72 open, and the first and second linear solenoid valves 51 and 52 serving as pressure regulating valves are controlled to regulate pressure of hydraulic oil from the oil passage L0 (pump 3 side), according to a requirement for the artificial muscle unit AM. Hydraulic oil whose pressure is regulated by the first linear solenoid valve 51 is supplied to the tube T of the hydraulic actuator M1 through the first on-off valve 71 and the oil passage L1, and hydraulic oil whose pressure is regulated by the second linear solenoid valve 52 is supplied to the tube T of the hydraulic actuator M2 through the second on-off valve 72 and the oil passage L2. By this, pressure of liquid from the pump 3 side is promptly regulated according to a requirement, by which the tubes T of the hydraulic actuators M1 and M2 axially contract with excellent responsiveness and high accuracy, enabling accurate adjustments to the pivot angle of the moving arm A and to forces transmitted to the moving arm A from the hydraulic actuators M1 and M2.

In addition, the control device 10 in the liquid supply device 1 can detect an abnormality in passage of currents through the electromagnetic parts 5e of the first and second linear solenoid valves 51 and 52 which is caused by a wire break, abnormal grounding, an abnormal increase in resistance value, etc., based on target currents and currents detected by the current detecting parts 15a and 15b. When the control device 10 has detected an abnormality in passage of a current through at least either one of the electromagnetic part 5e of the first and second linear solenoid valves 51 and 52, the control device 10 transmits the above-described off instruction to the valve drive control part 16a and/or 16a so as to stop output of signal pressure from the first and/or second on-off solenoid valves 61 and 62. Furthermore, when there has occurred a failure in a part of the control device 10 (other than the arithmetic processing part 11) in the liquid supply device 1, a failure in the liquid supply device 1, i.e., the pump 3, the first and second linear solenoid valves 51 and 52, etc., a failure in at least either one of the pressure sensor PS and the angle sensor AS, or an abnormality such as an increase in difference between a pivot angle detected by the angle sensor AS and a target pivot angle of the moving arm A, etc., the control device 10 transmits the above-described off instruction to the valve drive control parts 16a and 16a so as to stop output of signal pressure from the first and second on-off solenoid valves 61 and 62.

By this, when an abnormality (abnormal supply or abnormal stop) has occurred in supply of hydraulic oil from at least either one of the first and second linear solenoid valves 51 and 52 to the tube T of a corresponding one of the hydraulic actuators M1 and M2, at least either one of the first and second on-off valves 71 and 72 is closed according to the stop of output of signal pressure from the first and/or second on-off solenoid valves 61 and 62, by which supply of hydraulic oil to the tubes T of the hydraulic actuators M1 and/or M2 and an outflow of hydraulic oil from the tubes T are restricted. Namely, the first on-off solenoid valve 61 (electromagnetic part 6e) and the first on-off valve 71 function as a first inflow and outflow restricting part that restricts an inflow of hydraulic oil into the tube T of the hydraulic actuator M1 and an outflow of hydraulic oil from the tube T in a hydraulic oil passage that connects the tube T to the tank 2 and includes the oil passage L1, the output port 5o and drain port 5d of the first linear solenoid valve 51, and the oil passage L3. In addition, the second on-off solenoid valve 62 (electromagnetic part 6e) and the second on-off valve 72 function as a second inflow and outflow restricting part that restricts an inflow of hydraulic oil into the tube T of the hydraulic actuator M2 and an outflow of hydraulic oil from the tube T in a hydraulic oil passage that connects the tube T to the tank 2 and includes the oil passage L2, the output port 5o and drain port 5d of the second linear solenoid valve 52, and the oil passage L3.

In other words, the first on-off solenoid valve 61 and the first on-off valve 71 function as a liquid keeping part that allows the tube T of the hydraulic actuator M1 to keep therein hydraulic oil supplied to the hydraulic actuator M1, according to occurrence of some kind of abnormality. In addition, the second on-off solenoid valve 62 and the second on-off valve 72 function as a liquid keeping part that allows the tube T of the hydraulic actuator M2 to keep therein hydraulic oil supplied to the hydraulic actuator M2, according to occurrence of some kind of abnormality. Thus, even if an abnormality has occurred in, for example, supply of hydraulic oil from at least either one of the first and second linear solenoid valves 51 and 52 to a corresponding tube T, a sudden change in the state of the tube T is inhibited, by which occurrence of unintended operation of the moving arm A which is a drive target driven by the hydraulic actuators M1 and M2 can be excellently suppressed. As a result, according to the liquid supply device 1, the hydraulic actuators M1 and M2 serving as artificial muscles, i.e., the artificial muscle unit AM, can operate properly.

In addition, in the liquid supply device 1, as shown in FIG. 1, the first on-off valve 71 is disposed between the output port 5o of the first linear solenoid valve 51 and the tube T of the hydraulic actuator M1, and the second on-off valve 72 is disposed between the output port 5o of the second linear solenoid valve 52 and the tube T of the hydraulic actuator M2. By this, when an abnormality has occurred in supply of hydraulic oil from at least either one of the first and second linear solenoid valves 51 and 52 to a corresponding tube T, it becomes possible to suppress an outflow of liquid from the tube T extremely excellently. Note that pressure loss in the first and second on-off valves 71 and 72 occurring upon supply of hydraulic oil from the first and second linear solenoid valves 51 and 52 to their corresponding tubes T can be practically ignored.

Furthermore, in the liquid supply device 1, the first and second linear solenoid valves 51 and 52 are normally closed valves that open when currents are supplied to the electromagnetic parts 5e, and the first and second on-off valves 71 and 72 are normally closed valves that open when currents are supplied to the electromagnetic parts 6e of the first and second on-off solenoid valves 61 and 62. By this, when supply of hydraulic oil from the first and second linear solenoid valves 51 and 52 to the tubes T of the hydraulic actuators M1 and M2 is shut off due to power supply failure, the first and second on-off valves 71 and 72 are promptly closed, enabling restrictions on an outflow of hydraulic oil from each tube T.

In addition, the liquid supply device 1 connected to the plurality of hydraulic actuators M1 and M2 includes a single pump 3 and includes, for each of the plurality of hydraulic actuators M1 and M2, one linear solenoid valve and one pair of an on-off solenoid valve and an on-off valve (inflow and outflow restricting part). By this, compared to a case in which a dedicated pump is connected to each of the hydraulic actuators M1 and M2, the plurality of hydraulic actuators M1 and M2 can operate properly while the cost increase and size increase of the liquid supply device 1 are suppressed.

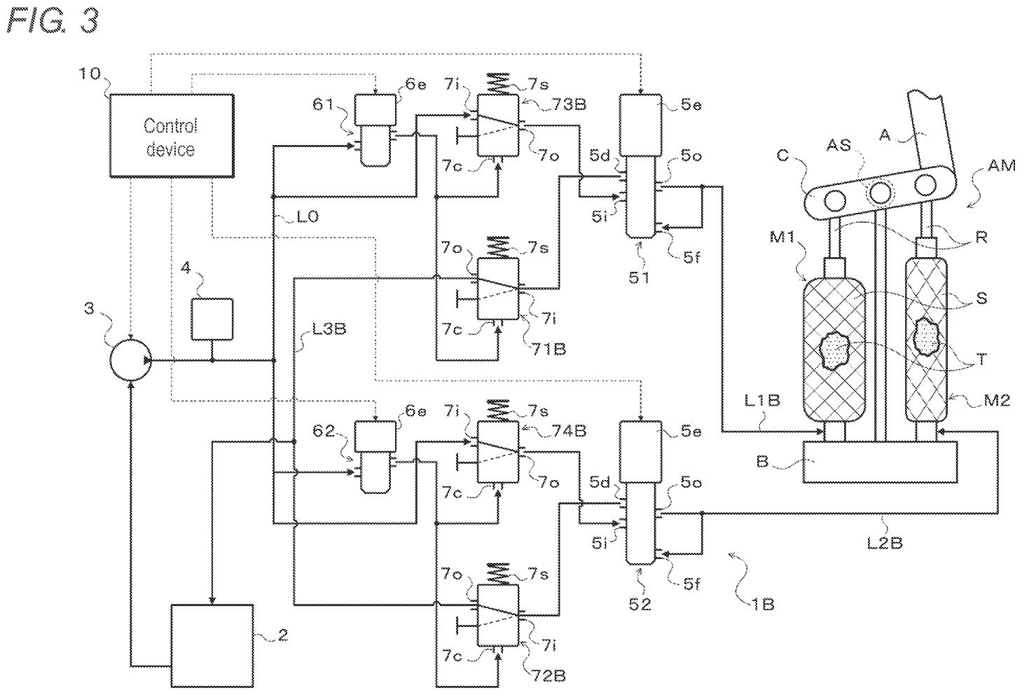

FIG. 3 is a schematic configuration diagram showing another liquid supply device 1B of the present disclosure. Note that of the components of the liquid supply device 1B, the same components as those of the above-described liquid supply device 1 are given the same reference signs and an overlapping description thereof is omitted.

As shown in FIG. 3, in the liquid supply device 1B, the output port 5o of the first linear solenoid valve 51 communicates with the inlet and outlet for hydraulic oil of the hydraulic actuator M1 (tube T) through an oil passage L1B formed in the valve body, and the output port 5o of the second linear solenoid valve 52 communicates with the inlet and outlet for hydraulic oil of the hydraulic actuator M2 (tube T) through an oil passage L2B formed in the valve body. In addition, first and second on-off valves 71B and 72B of the liquid supply device 1B are normally closed spool valves each including a spool which is not shown and a spring 7s, and are disposed in the valve body.

An input port 7i of the first on-off valve 71B communicates with the drain port 5d of the first linear solenoid valve 51 through an oil passage formed in the valve body, and an output port 7o of the first on-off valve 71B communicates with the inside of the tank 2 through an oil passage L3B formed in the valve body. Namely, the first on-off valve 71B is disposed between the drain port 5d of the first linear solenoid valve 51 and the tank 2. In addition, an input port 7i of the second on-off valve 72B communicates with the drain port 5d of the second linear solenoid valve 52 through an oil passage formed in the valve body, and an output port 7o of the second on-off valve 72B communicates with the inside of the tank 2 through the oil passage L3B formed in the valve body. Namely, the second on-off valve 72B is disposed between the drain port 5d of the second linear solenoid valve 52 and the tank 2.

When signal pressure is not supplied from the first or second on-off solenoid valve 61 or 62 to a corresponding signal pressure input port 7c, the spool of a corresponding one of the first and second on-off valves 71B and 72B shuts down communication between the input port 7i and the output port 7o by a biasing force of the spring 7s, and closes the output port 7o, i.e., the drain port 5d of a corresponding one of the first and second linear solenoid valves 51 and 52 (see a dashed line in the drawing). In addition, when signal pressure is supplied to the signal pressure input port 7c from the first or second on-off solenoid valve 61 or 62 according to passage of a current through the electromagnetic part 6e, the spool of a corresponding one of the first and second on-off valves 71B and 72B allows the input port 7i and the output port 7o to communicate with each other against a biasing force of the spring 7s (see a solid line in the drawing).

Furthermore, the liquid supply device 1B includes third and fourth on-off valves 73B and 74B. The third and fourth on-off valves 73B and 74B are normally closed spool valves, each of which includes a spool which is not shown, a spring 7s, an input port 7i, an output port 7o, and a signal pressure input port 7c that communicates with the output port of a corresponding one of the first and second on-off solenoid valves 61 and 62, and is disposed in the valve body. The input port 7i of the third on-off valve 73B communicates with the oil passage L0 in the valve body, and the output port 7o of the third on-off valve 73B communicates with the input port 5i of the first linear solenoid valve 51 through an oil passage formed in the valve body. Namely, the third on-off valve 73B is disposed between the pump 3 and the input port 5i of the first linear solenoid valve 51. The input port 7i of the fourth on-off valve 74B communicates with the oil passage L0 in the valve body, and the output port 7o of the fourth on-off valve 74B communicates with the input port 5i of the second linear solenoid valve 52 through an oil passage formed in the valve body. Namely, the fourth on-off valve 74B is disposed between the pump 3 and the input port 5i of the second linear solenoid valve 52.

When signal pressure is not supplied from the first or second on-off solenoid valve 61 or 62 to a corresponding signal pressure input port 7c, the spool of a corresponding one of the third and fourth on-off valves 73B and 74B shuts down communication between the input port 7i and the output port 7o by a biasing force of the spring 7s, and closes the output port 7o, i.e., the input port 5i of a corresponding one of the first and second linear solenoid valves 51 and 52 (see a dashed line in the drawing). In addition, when signal pressure is supplied to the signal pressure input port 7c from the first or second on-off solenoid valve 61 or 62 according to passage of a current through the electromagnetic part 6e, the spool of a corresponding one of the third and fourth on-off valves 73B and 74B allows the input port 7i and the output port 7o to communicate with each other against a biasing force of the spring 7s (see a solid line in the drawing).

When the control device 10 in the liquid supply device 1B such as that described above allows the artificial muscle unit AM to operate, the control device 10 opens the first and second on-off valves 71B and 72B and the third and fourth on-off valves 73B and 74B, and controls the first and second linear solenoid valves 51 and 52 serving as pressure regulating valves to supply hydraulic oil from the oil passage L0 (pump 3 side) to the tubes T of their corresponding hydraulic actuators M1 and M2 by regulating pressure of the hydraulic oil. At this time, the hydraulic oil from the pump 3 side is supplied to the input ports 5i of the first and second linear solenoid valves 51 and 52 through their corresponding opened third and fourth on-off valves 73B and 74B. Furthermore, hydraulic oil drained from the drain ports 5d of the first and second linear solenoid valves 51 and 52 flows into the tank 2 through their corresponding opened first and second on-off valves 71B and 72B and the oil passage L3B.

In addition, when the control device 10 in the liquid supply device 1B has detected some kind of abnormality such as an abnormality in passage of a current through at least either one of the electromagnetic parts 5e of the first and second linear solenoid valves 51 and 52, the control device 10 stops output of signal pressure from the first and/or second on-off solenoid valves 61 and 62 to close the first and/or second on-off valves 71B and 72B and the third and/or fourth on-off valves 73B and 74B. By this, when an abnormality has occurred in supply of hydraulic oil from at least either one of the first and second linear solenoid valves 51 and 52 to the tube T of a corresponding one of the hydraulic actuators M1 and M2, the drain port 5d of at least either one of the first and second linear solenoid valves 51 and 52 is closed by at least either one of the first and second on-off valves 71B and 72B, by which an outflow of hydraulic oil from the tube T is restricted. Furthermore, the input port 5i of at least either one of the first and second linear solenoid valves 51 and 52 is closed by at least either one of the third and fourth on-off valves 73B and 74B, by which supply (inflow) of hydraulic oil to a corresponding tube T is restricted.

Namely, the first on-off solenoid valve 61 (electromagnetic part 6e) and the first on-off valve 71B function as a first outflow restricting part that restricts an outflow of hydraulic oil from the tube T of the hydraulic actuator M1 in a hydraulic oil passage that connects the tube T to the tank 2 and includes the oil passage L1B, the output port 5o and drain port 5d of the first linear solenoid valve 51, and the oil passage L3B. In addition, the first on-off solenoid valve 61 (electromagnetic part 6e) and the third on-off valve 73B function as a first inflow restricting part that restricts supply (inflow) of hydraulic oil to the tube T of the hydraulic actuator M1 in a hydraulic oil passage that connects the pump 3 (tank 2) to the tube T and includes the oil passages L0 and L1B, etc. Furthermore, the second on-off solenoid valve 62 (electromagnetic part 6e) and the second on-off valve 72B function as a second outflow restricting part that restricts an outflow of hydraulic oil from the tube T of the hydraulic actuator M2 in a hydraulic oil passage that connects the tube T to the tank 2 and includes the oil passage L2B, the output port 5o and drain port 5d of the second linear solenoid valve 52, and the oil passage L3B. In addition, the second on-off solenoid valve 62 (electromagnetic part 6e) and the fourth on-off valve 74B function as a second inflow restricting part that restricts supply (inflow) of hydraulic oil to the tube T of the hydraulic actuator M2 in a hydraulic oil passage that connects the pump 3 (tank 2) to the tube T and includes the oil passages L0 and L2B, etc.

In other words, the first on-off solenoid valve 61 and the first and third on-off valves 71B and 73B function as a liquid keeping part that allows the tube T of the hydraulic actuator M1 to keep therein hydraulic oil supplied to the hydraulic actuator M1, according to occurrence of some kind of abnormality. In addition, the second on-off solenoid valve 62 and the second and fourth on-off valves 72B and 74B function as a liquid keeping part that allows the tube T of the hydraulic actuator M2 to keep therein hydraulic oil supplied to the hydraulic actuator M2, according to occurrence of some kind of abnormality. By this, in the liquid supply device 1B, too, when an abnormality has occurred in supply of hydraulic oil from at least either one of the first and second linear solenoid valves 51 and 52 to a corresponding tube T, a sudden change in the state of the tube T is inhibited, by which occurrence of unintended operation of the moving arm A driven by the hydraulic actuators M1 and M2 can be excellently suppressed. As a result, the hydraulic actuators M1 and M2 serving as artificial muscles, i.e., the artificial muscle unit AM, can operate properly. In addition, in the liquid supply device 1B, although the amount of hydraulic oil leaking from the tubes T upon occurrence of an abnormality somewhat increases compared to the above-described liquid supply device 1, since hydraulic oil can be more smoothly supplied to the tubes T of the hydraulic actuators M1 and M2 from the first and second linear solenoid valves 51 and 52 by suppressing an increase in pressure loss in the oil passages L1B and L2B, responsiveness of the hydraulic actuators M1 and M2 can be further improved. Note that instead of the third and fourth on-off valves 73B and 74B, a single on-off valve may be provided in an oil passage that connects the tank 2 (liquid storage part) to the pump 3. In addition, to the signal pressure input ports 7c of the third and fourth on-off valves 73B and 74B there may be individually supplied signal pressure from their corresponding on-off solenoid valves.

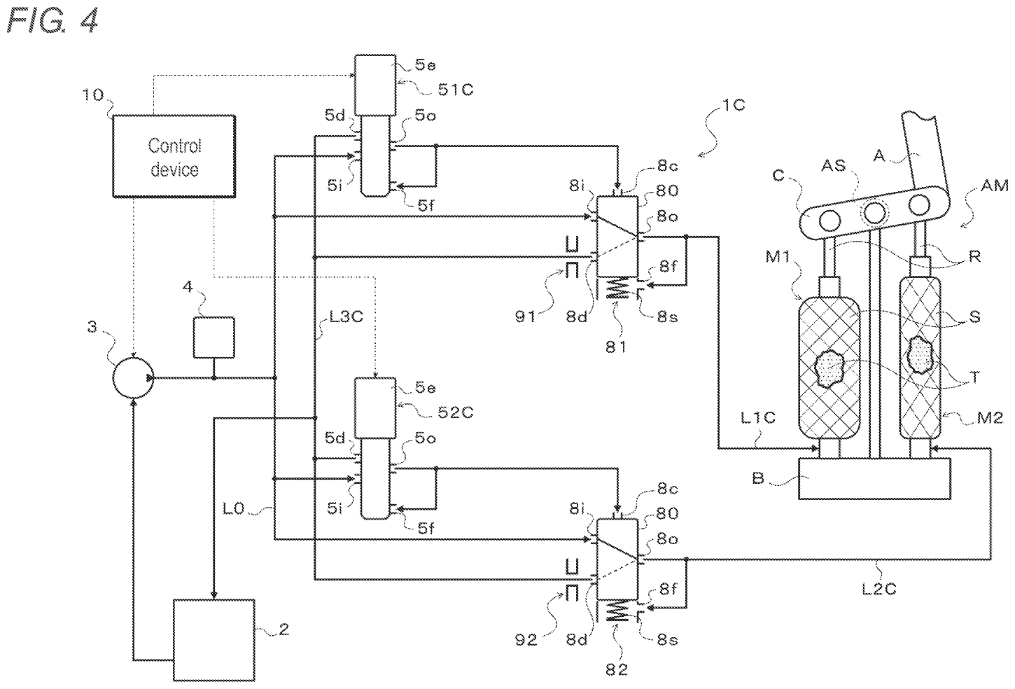

FIG. 4 is a schematic configuration diagram showing still another liquid supply device 1C of the present disclosure. Note that of the components of the liquid supply device 1C, the same components as those of the above-described liquid supply devices 1 and 1B are given the same reference signs and an overlapping description thereof is omitted.

The liquid supply device 1C shown in FIG. 4 includes, as pressure regulating valves for the hydraulic actuator M1, a first linear solenoid valve 51C of a normally closed type that outputs signal pressure generated based on a current supplied to an electromagnetic part 5e, and a first control valve 81 that regulates pressure of hydraulic oil according to the signal pressure from the first linear solenoid valve 51C, and includes, as pressure regulating valves for the hydraulic actuator M2, a second linear solenoid valve 52C of a normally closed type that outputs signal pressure generated based on a current supplied to an electromagnetic part 5e, and a second control valve 82 that regulates pressure of hydraulic oil according to the signal pressure from the second linear solenoid valve 52C. The first and second control valves 81 and 82 each are a normally closed spool valve including a spool 80 and a spring 8s, and are disposed in the valve body.

The first control valve 81 includes an input port 8i that communicates with the oil passage L0 formed in the valve body; an output port 8o that communicates with the inlet and outlet for hydraulic oil of the hydraulic actuator M1 (tube T) through an oil passage L1C formed in the valve body; a feedback port 8f that communicates with the output port 8o; a signal pressure input port 8c that communicates with an output port 5o of the first linear solenoid valve 51C through an oil passage formed in the valve body; and a drain port 8d that communicates with the inside of the tank 2 through an oil passage L3C formed in the valve body. In addition, the second control valve 82 includes an input port 8i that communicates with the oil passage L0 formed in the valve body; an output port 8o that communicates with the inlet and outlet for hydraulic oil of the hydraulic actuator M2 (tube T) through an oil passage L2C formed in the valve body; a feedback port 8f that communicates with the output port 8o; a signal pressure input port 8c that communicates with an output port 5o of the second linear solenoid valve 52C through an oil passage formed in the valve body; and a drain port 8d that communicates with the inside of the tank 2 through the oil passage L3C formed in the valve body.

The first and second control valves 81 and 82 each allow the spool 80 to axially move against a biasing force of the spring 8s by signal pressure from a corresponding one of the first and second linear solenoid valves 51C and 52C which is generated based on a current applied to the electromagnetic part 5e. By this, thrust given to the spool 80 by action of signal pressure, a biasing force of the spring 8s, and thrust acting on the spool 80 by oil pressure supplied to the feedback port 8f from the output port 8o are balanced, by which a part of hydraulic oil from the pump 3 side that is supplied to the input port 8i is drained from the drain port 8d as appropriate, and pressure of hydraulic oil supplied to the tube T of the hydraulic actuator M1 or M2 from the output port 8o can be regulated to desired pressure.

In the liquid supply device 1C, there are provided, in the oil passage L3C that communicates with the tank 2, a first orifice 91 in proximity to the drain port 8d of the first control valve 81, and a second orifice 92 in proximity to the drain port 8d of the second control valve 82. By this, when output of signal pressure from at least either one of the first and second linear solenoid valves 51C and 52C is stopped due to an abnormality in passage of a current through the electromagnetic part 5e, and thus, at least either one of the first and second control valves 81 and 82 is closed and supply of hydraulic oil to a corresponding tube T is stopped, an outflow of hydraulic oil from the tube T is restricted by at least either one of the first and second orifices 91 and 92. As a result, by the liquid supply device 1C, too, a sudden change in the state of the tube T is inhibited, by which occurrence of unintended operation of the moving arm A driven by the hydraulic actuators M1 and M2 can be excellently suppressed, and thus, the hydraulic actuators M1 and M2 serving as artificial muscles, i.e., the artificial muscle unit AM, can operate properly.

Note that in the above-described liquid supply devices 1 and 1B, the first and second linear solenoid valves 51 and 52 may be replaced by a linear solenoid valve that outputs signal pressure generated based on a current supplied to an electromagnetic part, and a control valve that regulates pressure of hydraulic oil according to the signal pressure. In addition, in the liquid supply devices 1 and 1B, the first on-off solenoid valve 61 and the first on-off valve 71 or 71B may be replaced by a two-way solenoid valve including a disc that is opened and closed by an electromagnetic part, and the second on-off solenoid valve 62 and the second on-off valve 72 or 72B may be replaced by a two-way solenoid valve including a disc that is opened and closed by an electromagnetic part. Furthermore, the liquid supply devices 1 and 1B may include a regulator valve (pressure regulating valve) that regulates pressure of hydraulic oil from the pump 3 according to signal pressure from a signal pressure output valve, and supplies the hydraulic oil to the oil passage L0. In addition, the liquid supply devices 1, 1B, and 1C may supply liquid other than hydraulic oil, such as water, to the hydraulic actuators M1 and M2, and may be configured to supply and discharge liquid to/from a single or three or more hydraulic actuators. Furthermore, the first and second linear solenoid valves 51 and 52 each may be replaced by a flow control valve that is controlled such that liquid pressure (oil pressure) supplied to a corresponding one of the hydraulic actuators M1 and M2 reaches target pressure. In addition, at least either one of the first and second linear solenoid valves 51 and 52 may be a normally open valve. In this case, the normally open valve may balance thrust from an electromagnetic part and thrust generated by liquid pressure that is supplied to a feedback port such that the thrust acts in the same direction as the thrust from the electromagnetic part, with a biasing force of a spring. At least either one of the first and second linear solenoid valves 51 and 52 may be configured such that the first or second linear solenoid valve 51 or 52 does not have a dedicated feedback port, and output pressure acts as feedback pressure on a spool inside a sleeve that holds the spool (see, for example, JP 2020-41687 A).

Furthermore, in the above-described embodiment, although the hydraulic actuators M1 and M2 serving as artificial muscles are McKibben artificial muscles each including: a tube T into which hydraulic oil is supplied and which axially contracts while radially expanding in accordance with an increase in oil pressure inside the tube T; and a braided sleeve S that covers the tube T, the configuration of the hydraulic actuators M1 and M2 in the artificial muscle unit AM is not limited thereto. Namely, the hydraulic actuators M each may be any hydraulic actuator as long as the hydraulic actuator includes a tube that axially contracts while radially expanding upon supply of liquid, and may be, for example, an axially fiber-reinforced hydraulic actuator including an inner tubular member formed of an elastic body; an outer tubular member formed of an elastic body and coaxially disposed on an outer side of the inner tubular member; and a fiber layer disposed between the inner tubular member and the outer tubular member (see, for example, JP 2011-137516 A).

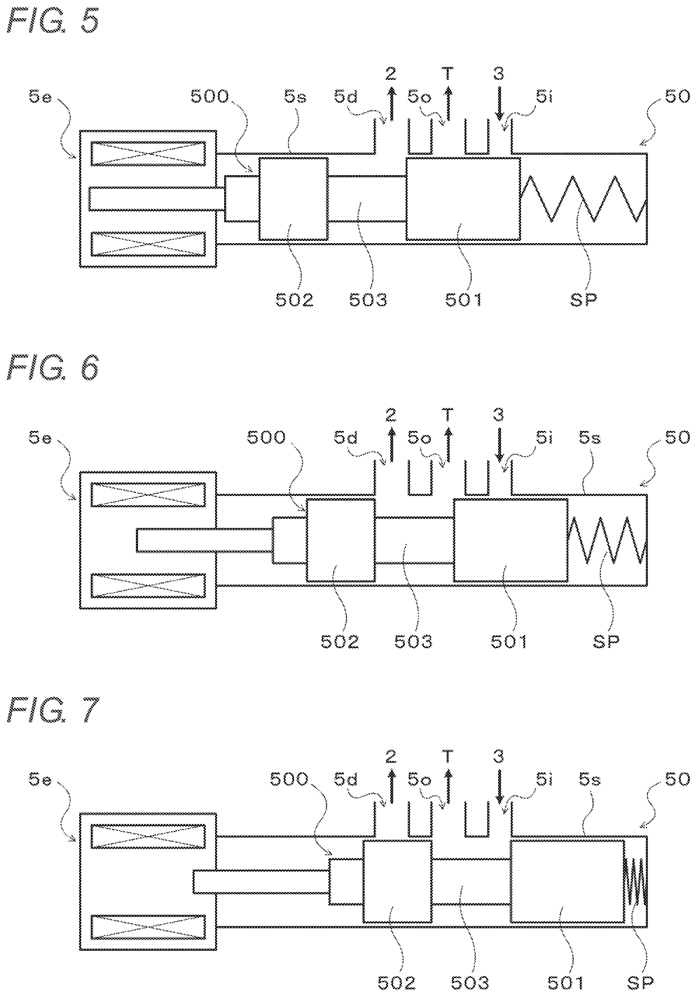

FIG. 5 is a schematic configuration diagram showing another linear solenoid valve 50 that can be applied to the above-described liquid supply device 1. Note that of the components of the linear solenoid valve 50, the same components as those of the above-described first and second linear solenoid valves 51 and 52 are given the same reference signs and an overlapping description thereof is omitted.

The linear solenoid valve 50 shown in FIG. 6 plays by itself the role of a set of the first linear solenoid valve 51, the first on-off solenoid valve 61, and the first on-off valve 71 or a set of the second linear solenoid valve 52, the second on-off solenoid valve 62, and the second on-off valve 72 of the above-described liquid supply device 1. As shown in FIG. 5, the linear solenoid valve 50 includes a sleeve 5s having an input port 5i, an output port 5o, a drain port 5d, and a feedback port which is not shown; a spool 500 disposed in the sleeve 5s so as to be axially slidable (movable); an electromagnetic part 5e whose current passage is controlled by a control device which is not shown, to move the spool 500; and a spring SP that biases the spool 500 toward an electromagnetic part 5e side.

In the linear solenoid valve 50, the input port 5i, the output port 5o, and the drain port 5d are formed in the sleeve 5s so as to be axially arranged side by side in this order from a spring SP side to the electromagnetic part 5e side, with spacing therebetween. Namely, the output port 5o is formed on the electromagnetic part 5e side of the input port 5i, and the drain port 5d is formed on the electromagnetic part 5e side of the output port 5o. Hydraulic oil from the pump 3 side is supplied to the input port 5i of the linear solenoid valve 50, and the output port 5o communicates with an inlet and an outlet for hydraulic oil of a tube T through an oil passage. Furthermore, the drain port 5d communicates with the inside of the tank 2.

The spool 500 of the linear solenoid valve 50 includes a first land 501 on the spring SP side; a second land 502 more on the electromagnetic part 5e side than the first land 501; and a shaft part 503 between the first land 501 and the second land 502. The first and second lands 501 and 502 are formed in cylindrical shapes having the same outside diameter (cross-sectional area), and the shaft part 503 is formed in a cylindrical shape having a smaller inside diameter (cross-sectional area) than the outside diameter (cross-sectional area) of the first and second lands 501 and 502. The first and second lands 501 and 502 and the shaft part 503 extend coaxially with each other along the shaft center of the spool 500.

In a mounting state (upon no current passage) in which a current is not supplied to the electromagnetic part 5e of the linear solenoid valve 50 and the spool 500 is biased toward the electromagnetic part 5e side by the spring SP, the input port 5i and the output port 5o are closed by the first land 501 of the spool 500, by which communication between the output port 5o and the input port 5i and the drain port 5d is shut down. In addition, upon current passage where a current is supplied to the electromagnetic part 5e, the spool 500 moves toward the spring SP side against a biasing force of the spring SP, and as shown in FIG. 6, the closure of the output port 5o by the first land 501 is gradually released, by which the output port 5o communicates with the drain port 5d. Furthermore, according to an increase in the value of a current supplied to the electromagnetic part 5e, the spool 500 further moves toward the spring SP side, and as shown in FIG. 7, the closure of the input port 5i by the first land 501 is gradually released, by which the input port 5i communicates with the output port 5o. By this, it becomes possible to regulate pressure of hydraulic oil supplied to the tube T from the output port 5o, according to the value of a current supplied to the electromagnetic part 5e.

In addition, for example, when passage of a current through the electromagnetic part 5e is stopped due to occurrence of an abnormality such as power supply failure, resulting in occurrence of an abnormality (abnormal stop) in supply of hydraulic oil to the tube T from the linear solenoid valve 50, the spool 500 of the linear solenoid valve 50 returns to a position in the mounting state shown in FIG. 5 by a biasing force of the spring SP. By this, the output port 5o is closed by the first land 501 of the spool 500 and communication between the output port 5o and the input port 5i and the drain port 5d is shut down, by which an outflow of hydraulic oil from the tube T is restricted. Namely, the first land 501 of the spool 500 of the linear solenoid valve 50 functions as an inflow restricting part that restricts an inflow of hydraulic oil into the tube T in a hydraulic oil passage that connects the pump 3 (tank 2) to the tube T, and functions as an outflow restricting part that restricts an outflow of hydraulic oil from the tube T in the hydraulic oil passage that connects the tube T to the tank 2. Thus, by applying the linear solenoid valve 50 to the liquid supply device 1, it becomes possible to achieve the cost reduction and size and weight reduction of the liquid supply device 1 by a reduction in the number of parts.

Note that although the linear solenoid valve 50 includes the spring SP as a biasing member that biases the spool 500, a biasing member including a magnet may be used. Note also that upon current passage, the electromagnetic part 5e of the linear solenoid valve 50 may allow the spool 500 to move by its own weight against a biasing force acting on the spool 500.

FIG. 8 is a schematic configuration diagram showing still another linear solenoid valve 50B that can be applied to the above-described liquid supply device 1. Note that of the components of the linear solenoid valve 50B, the same components as those of the above-described linear solenoid valve 50, etc., are given the same reference signs and an overlapping description thereof is omitted.

The linear solenoid valve 50B shown in FIG. 8 also plays by itself the role of a set of the first linear solenoid valve 51, the first on-off solenoid valve 61, and the first on-off valve 71 or a set of the second linear solenoid valve 52, the second on-off solenoid valve 62, and the second on-off valve 72 of the above-described liquid supply device 1. As shown in FIG. 8, the linear solenoid valve 50B includes an input port 5i, an output port 5o, a drain port 5d, a feedback port which is not shown, a spool 500B, and an electromagnetic part 5x whose current passage is controlled by a control device which is not shown, to move the spool 500B.

Hydraulic oil from the pump 3 side is supplied to the input port 5i of the linear solenoid valve 50B, and the output port 5o communicates with an inlet and an outlet for hydraulic oil of a tube T through an oil passage. Furthermore, the drain port 5d communicates with the inside of the tank 2. The electromagnetic part 5x includes a yoke Y; a tubular coil C disposed in the yoke Y; and a plunger X that is supported by the yoke Y so as to be enclosed by the coil C and to be axially movable (slidable) and connected to the spool 500B. In addition, an annular axial gap G is formed in the yoke Y so as to enclose the plunger X. Furthermore, a tubular permanent magnet M which is radially magnetized is fixed to the plunger X. In the present embodiment, the axial length of the permanent magnet M is set to be longer than the axial length of the gap G.

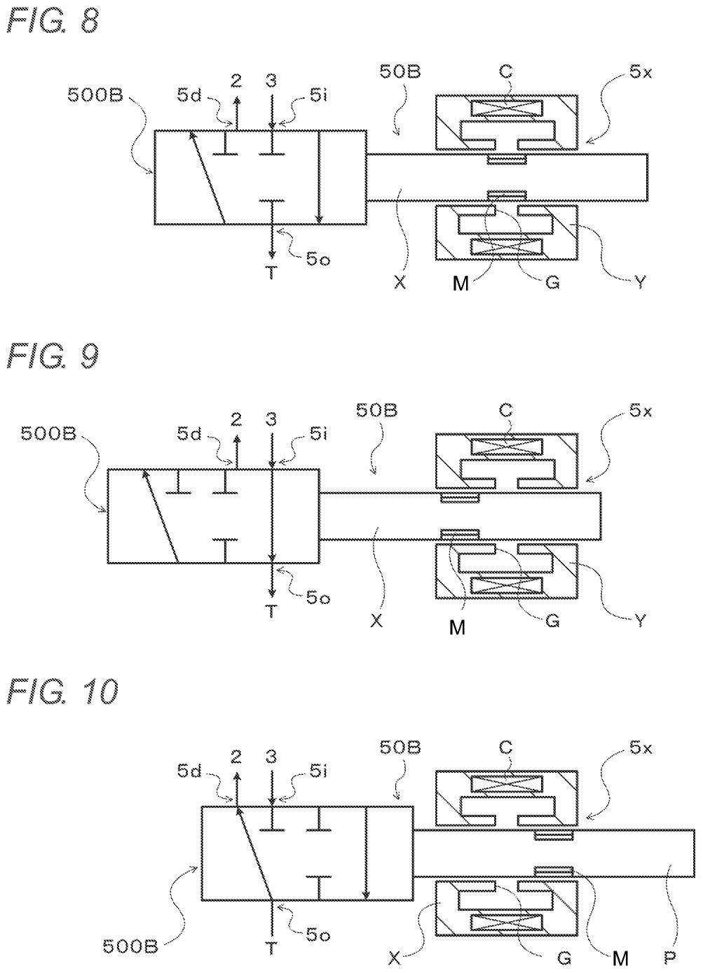

In a state in which a current is not supplied to the electromagnetic part 5x of the linear solenoid valve 50B, i.e., a mounting state (upon no current passage), the axial center of the permanent magnet M fixed to the plunger X overlaps the axial center of the gap G by a magnetic force acting between the yoke Y and the permanent magnet M. At this time, the spool 500B shuts down communication between the input port 5i and the output port 5o and communication between the output port 5o and the drain port 5d. In addition, when the direction of a current supplied to the coil C is a positive direction (one direction), as shown in FIG. 9, the electromagnetic part 5x allows the spool 500B to move against a magnetic force of the permanent magnet M so that pressure of hydraulic oil from the pump 3 side to the input port 5i is regulated and the hydraulic oil is supplied into the tube T through the output port 5o. By this, it becomes possible to regulate pressure of hydraulic oil which is supplied to the tube T from the output port 5o, according to the value (absolute value) of a current supplied to the electromagnetic part 5x (coil C). Furthermore, when the direction of a current supplied to the coil C is a negative direction (other direction), as shown in FIG. 10, the electromagnetic part 5x allows the spool 500B to move against a magnetic force of the permanent magnet M so that hydraulic oil in the tube T flows out into the tank 2 through the drain port 5d.

In addition, for example, when passage of a current through the coil C of the electromagnetic part 5x is stopped due to occurrence of an abnormality such as power supply failure, resulting in occurrence of an abnormality (abnormal stop) in supply of hydraulic oil to the tube T from the linear solenoid valve 50B, the spool 500B of the linear solenoid valve 50B returns to a position in the mounting state shown in FIG. 8 by a magnet force of the permanent magnet M. By this, communication between the input port 5i and the output port 5o and communication between the output port 5o and the drain port 5d are shut down by the spool 500B, by which an outflow of hydraulic oil from the tube T is restricted. Namely, the spool 500B of the linear solenoid valve 50B also functions as an inflow restricting part that restricts an inflow of hydraulic oil into the tube T in a hydraulic oil passage that connects the pump 3 (tank 2) to the tube T, and functions as an outflow restricting part that restricts an outflow of hydraulic oil from the tube T in the hydraulic oil passage that connects the tube T to the tank 2. Thus, by applying the linear solenoid valve 50B to the liquid supply device 1, too, it becomes possible to achieve the cost reduction and size and weight reduction of the liquid supply device 1 by a reduction in the number of parts.

As described above, a robot device of the present disclosure is a robot device (AM) including at least one artificial muscle (M1, M2) that operates by being supplied with liquid; and a liquid supply device (1, 1B, 1C) that supplies and discharges the liquid to/from the artificial muscle (M1, M2), and the liquid supply device (1, 1B, 1C) includes a liquid storage part (2) that stores the liquid; a pressure regulating valve (51, 51C, 81, 52, 52C, 82, 50, 50B) that regulates pressure of the liquid from the liquid storage part (2) and supplies the liquid to the artificial muscle (M1, M2); and a liquid keeping part (61, 71, 71B, 73B, 91, 62, 72, 72B, 74B, 92, 500, 500B) that allows the artificial muscle (M1, M2) to keep the liquid supplied to the artificial muscle (M1, M2), according to occurrence of an abnormality.

In the robot device of the present disclosure, pressure of liquid from a liquid storage part side is regulated by the pressure regulating valve and the liquid is supplied to the artificial muscle. By this, pressure of liquid from the liquid storage part side is promptly regulated according to a requirement, enabling the artificial muscle to operate with excellent responsiveness and high accuracy. Furthermore, when some kind of abnormality has occurred, the liquid keeping part of the liquid supply device allows the artificial muscle to keep liquid (the amount of liquid pressure or liquid) supplied to the artificial muscle. By this, even if some kind of abnormality has occurred, a sudden change in the state of the artificial muscle is inhibited, by which occurrence of unintended operation of a drive target which is driven by the artificial muscle can be excellently suppressed. As a result, the robot device of the present disclosure can allow the artificial muscle to operate properly.

In addition, the liquid supply device (1, 1B) may further include a pump (3) that sucks the liquid from the liquid storage part (2) and discharges the liquid, the pressure regulating valve (51, 52) may regulate pressure of the liquid from the pump (3) and supply the liquid to the artificial muscle (M1, M2), and the liquid keeping part may include at least one valve (61, 71, 71B, 73B, 62, 72, 72B, 74B, 500, 500B) that allows the artificial muscle (M1, M2) to keep the liquid supplied to the artificial muscle (M1, M2), according to occurrence of the abnormality.

Furthermore, the robot device (AM) may include a sensor (AS) that detects the amount of movement of a drive target (C, A) driven by the artificial muscle (M1, M2), and the abnormality may include at least any one of a failure in a control device (10) in the liquid supply device (1, 1B, 1C), a failure in the liquid supply device (1, 1B, 1C), a failure in the sensor (AS), and an increase in difference between the amount of movement detected by the sensor (AS) and a target amount of movement of the drive target (C, A).

In addition, the liquid keeping part may include an outflow restricting part (61, 71, 71B, 91, 62, 72, 72B, 92, 500, 500B) that is provided in a liquid passage connecting the artificial muscle (M1, M2) to the liquid storage part (2), and restricts an outflow of the liquid from the artificial muscle (M1, M2) when the abnormality has occurred.

Furthermore, the outflow restricting part (71, 72) may be disposed between an output port (5o) of the pressure regulating valve (51, 52) and the artificial muscle (M1, M2). By this, when an abnormality has occurred in supply of liquid to the artificial muscle from the pressure regulating valve, it becomes possible to suppress an outflow of liquid from the artificial muscle extremely excellently.

In addition, the outflow restricting part (71B, 91, 72B, 92) may be disposed between a drain port (5d, 8d) of the pressure regulating valve (51, 81, 52, 82) and the liquid storage part (2). By this, it becomes possible to more smoothly supply liquid to the artificial muscle from the pressure regulating valve, enabling a further improvement in responsiveness of the artificial muscle.

Furthermore, the pressure regulating valve (51, 51C, 81, 52, 52C, 82) may include an electromagnetic part (5e) controlled by the control device (10), the outflow restricting part may include an on-off valve (61, 62, 71, 71B, 72, 72B) controlled by the control device (10), and the control device (10) may be able to detect an abnormality in passage of a current through the electromagnetic part (5e) of the pressure regulating valve (51, 51C, 81, 52, 52C, 82), and close the on-off valve (71, 71B, 72, 72B) when the abnormality in passage of a current is detected. In this case, the pressure regulating valve may be a linear solenoid valve (51, 52) including an electromagnetic part (5e), or may include a solenoid valve (51C, 52C) that outputs signal pressure generated based on a current supplied to an electromagnetic part (5e), and a spool valve (81, 82) that regulates pressure of liquid according to the signal pressure. In addition, the on-off valve (71, 71B, 72, 72B) may be a valve (spool valve) that is opened and closed according to signal pressure from a solenoid valve (61, 62) that outputs the signal pressure which is generated based on a current supplied to an electromagnetic part (6e), or may be a two-way solenoid valve including a disc that is opened and closed by an electromagnetic part.

In addition, the liquid keeping part may include an inflow restricting part (61, 71, 73B, 62, 72, 74, 500, 500B) that is provided in a liquid passage connecting the artificial muscle (M1, M2) to the liquid storage part (2), and restricts an inflow of the liquid into the artificial muscle (M1, M2) when the abnormality has occurred.

Furthermore, the inflow restricting part (71, 72) may be disposed between an output port (5o) of the pressure regulating valve (51, 52) and the artificial muscle (M1, M2.

In addition, the inflow restricting part (73B, 74B) may be disposed between the liquid storage part (2) and an input port (5i) of the pressure regulating valve (51, 52).

Furthermore, the liquid supply device (1, 1B, 1C) may be connected to a plurality of the artificial muscles (M1, M2), and may include the single pump (3) and include, for each of the plurality of the artificial muscles (M1, M2), one each of the pressure regulating valve (51, 51C, 81, 52, 52C, 82) and the outflow restricting part (61, 71, 71B, 73B, 91, 62, 72, 72B, 74B, 92, 50, 50B). By this, the plurality of artificial muscles can operate properly while the cost increase and size increase of the liquid supply device are suppressed.

The artificial muscle (M1, M2) may axially contract while radially expanding when the liquid is supplied.

A liquid supply device of the present disclosure is a liquid supply device (1, 1B, 1C) that supplies and discharges liquid to/from at least one artificial muscle (M1, M2) that operates by being supplied with the liquid, and includes a liquid storage part (2) that stores the liquid; a pressure regulating valve (51, 51C, 81, 52, 52C, 82, 50, 50B) that regulates pressure of the liquid from the liquid storage part (2) and supplies the liquid to the artificial muscle (M1, M2); and a liquid keeping part (61, 71, 71B, 73B, 91, 62, 72, 72B, 74B, 92, 500, 500B) that allows the artificial muscle (M1, M2) to keep the liquid supplied to the artificial muscle (M1, M2), according to occurrence of an abnormality.

The liquid supply device of the present disclosure regulates, by the pressure regulating valve, pressure of liquid from the liquid storage part side, and supplies the liquid to the artificial muscle. By this, pressure of liquid from the liquid storage part side is promptly regulated according to a requirement, enabling the artificial muscle to operate with excellent responsiveness and high accuracy. Furthermore, when some kind of abnormality has occurred, the liquid keeping part of the liquid supply device allows the artificial muscle to keep liquid supplied to the artificial muscle. By this, even if some kind of abnormality has occurred, a sudden change in the state of the artificial muscle is inhibited, by which occurrence of unintended operation of a drive target which is driven by the artificial muscle can be excellently suppressed. As a result, according to the liquid supply device of the present disclosure, the artificial muscle can operate properly.

In addition, the liquid supply device (1, 1B) may further include a pump (3) that sucks the liquid from the liquid storage part (2) and discharges the liquid, the pressure regulating valve (51, 52) may regulate pressure of the liquid from the pump (3) and supply the liquid to the artificial muscle (M1, M2), and the liquid keeping part may include at least one valve (61, 71, 71B, 73B, 62, 72, 72B, 74B, 500, 500B) that allows the artificial muscle (M1, M2) to keep the liquid supplied to the artificial muscle (M1, M2), according to occurrence of the abnormality.

Furthermore, the abnormality may include a failure in a control device (10) in the liquid supply device (1, 1B, 1C), a failure in the pressure regulating valve (51, 51C, 81, 52, 52C, 82, 50, 50B), a failure in a sensor (AS), and an increase in difference between an amount of movement detected by the sensor (AS) and a target amount of movement of a drive target (C, A).

There is no intention that the invention of the present disclosure be limited to the above-described embodiment, and needless to say, various changes that fall within the extensive range of the present disclosure can be made. Furthermore, the above-described embodiment is merely a specific embodiment of the invention described in the “SUMMARY OF DISCLOSURE” section, and is not intended to limit the elements of the invention described in the “SUMMARY OF DISCLOSURE” section.

### INDUSTRIAL APPLICABILITY

Aspects of the present disclosure can be used in, for example, manufacturing industries for a robot device including at least one artificial muscle that operates by being supplied with liquid, and a liquid supply device that supplies and discharges liquid to/from the artificial muscle.

1. A robot device comprising: at least one artificial muscle that operates by being supplied with liquid; and a liquid supply device that supplies and discharges the liquid to/from the artificial muscle,
wherein
the liquid supply device includes:
a liquid storage part that stores the liquid;
a pressure regulating valve that regulates pressure of the liquid from the liquid storage part and supplies the liquid to the artificial muscle; and
a liquid keeping part that allows the artificial muscle to keep the liquid supplied to the artificial muscle, according to occurrence of an abnormality.

2. The robot device according to claim 1,
wherein
the liquid supply device further includes a pump that sucks the liquid from the liquid storage part and discharges the liquid,
the pressure regulating valve regulates pressure of the liquid from the pump and supplies the liquid to the artificial muscle, and
the liquid keeping part includes at least one valve that allows the artificial muscle to keep the liquid supplied to the artificial muscle, according to occurrence of the abnormality.

3. The robot device according to claim 1, further comprising a sensor that detects an amount of movement of a drive target driven by the artificial muscle,
wherein
the abnormality includes at least any one of a failure in a control device in the liquid supply device, a failure in the liquid supply device, a failure in the sensor, and an increase in difference between the amount of movement detected by the sensor and a target amount of movement of the drive target.

4. The robot device according to claim 1, wherein the liquid keeping part includes an outflow restricting part that is provided in a liquid passage connecting the artificial muscle to the liquid storage part, and restricts an outflow of the liquid from the artificial muscle when the abnormality has occurred.

5. The robot device according to claim 4, wherein the outflow restricting part is disposed between an output port of the pressure regulating valve and the artificial muscle.

6. The robot device according to claim 4, wherein the outflow restricting part is disposed between a drain port of the pressure regulating valve and the liquid storage part.

7. The robot device according to claim 4,
wherein
the pressure regulating valve includes an electromagnetic part controlled by a control device in the liquid supply device,
the outflow restricting part includes an on-off valve controlled by the control device, and
the control device can detect an abnormality in passage of a current through the electromagnetic part of the pressure regulating valve, and closes the on-off valve when the abnormality in passage of a current is detected.

8. The robot device according to claim 1, wherein the liquid keeping part includes an inflow restricting part that is provided in a liquid passage connecting the artificial muscle to the liquid storage part, and restricts an inflow of the liquid into the artificial muscle when the abnormality has occurred.

9. The robot device according to claim 8, wherein the inflow restricting part is disposed between an output port of the pressure regulating valve and the artificial muscle.

10. The robot device according to claim 8, wherein the inflow restricting part is disposed between the liquid storage part and an input port of the pressure regulating valve.

11. The robot device according to claim 1, wherein the liquid supply device is connected to a plurality of the artificial muscles, and includes the single pump and includes, for each of the plurality of the artificial muscles, one each of the pressure regulating valve and the outflow restricting part.

12. The robot device according to claim 1, wherein the artificial muscle axially contracts while radially expanding when the liquid is supplied.

13. A liquid supply device that supplies liquid to at least one artificial muscle that operates by being supplied with the liquid, the liquid supply device comprising:
a liquid storage part that stores the liquid;
a pressure regulating valve that regulates pressure of the liquid from the liquid storage part and supplies the liquid to the artificial muscle; and
a liquid keeping part that allows the artificial muscle to keep the liquid supplied to the artificial muscle, according to occurrence of an abnormality.

14. The liquid supply device according to claim 13, further comprising a pump that sucks the liquid from the liquid storage part and discharges the liquid,
wherein
the pressure regulating valve regulates pressure of the liquid from the pump and supplies the liquid to the artificial muscle, and
the liquid keeping part includes at least one valve that allows the artificial muscle to keep the liquid supplied to the artificial muscle, according to occurrence of the abnormality.

15. The liquid supply device according to claim 13, wherein the abnormality includes a failure in a control device in the liquid supply device, a failure in the pressure regulating valve, a failure in a sensor that detects an amount of movement of a drive target driven by the artificial muscle, and an increase in difference between the amount of movement detected by the sensor and a target amount of movement of the drive target.
